(19) United States
(12) Patent Application Publication
(10) Pub. No.: US 2024/0311456 A1
(43) Pub. Date: Sep. 19, 2024

(54) SYSTEM AND METHOD FOR SECURE AUTHENTICATION WITH BEHAVIORAL BIOMETRICS

(71) Applicant: Capital One Services, LLC, McLean, VA (US)

(72) Inventors: Jennifer KWOK, Brooklyn, NY (US); Phoebe ATKINS, Midlothian, VA (US); Viraj CHAUDHARY, Katy, TX (US); Leeyat Bracha TESSLER, Arlington, VA (US); Tyler MAIMAN, Melville, NY (US); Ray CHENG, Long Island City, NY (US); Vyjayanthi VADREVU, Pflugerville, TX (US); Michael SAIA, Weehawken, NJ (US)

(21) Appl. No.: 18/122,628

(22) Filed: Mar. 16, 2023

(51) Int. Cl. G06F 21/32

(52) U.S. Cl. CPC G06F 21/32

(57) ABSTRACT

The present embodiments disclose systems and methods for authenticating a user with behavioral biometrics associated with a card. The card includes an accelerometer configured to measure the orientation of the card body. The system includes the card and a software application. The software application generates a user profile based on observed card biometrics, then determines whether a recent transaction significantly deviates from the profile.

### FIELD OF DISCLOSURE

The present disclosure relates to systems and methods for securely authenticating a user with behavioral biometrics.

### BACKGROUND

For many consumers, a transaction card, such as a credit card or debit card, is the most common way to perform transactions. Thus, it is important to protect the user from misuse of the card. While many methods offer some security, deficiencies remain. For example, a two-factor authentication requiring the presence of both a card and a cellphone can nonetheless be passed if a fraudulent party steals both the card and the cellphone.

These and other deficiencies exist. Therefore, there is a need to provide systems and methods that overcome these deficiencies and provide for secure authentication of a user.

### SUMMARY OF THE DISCLOSURE

Aspects of the disclosed embodiments include a card, system, and method for measuring a user's behavioral biometrics and using them to verify a user prior to performing a transaction.

Embodiments of the present disclosure provide a method comprising the following steps: First, the method proceeds with recording, by a processor, one or more biometrics associated with a card and storing, by a processor, the biometrics on a server. Next, the method proceeds with generating, by the processor, a biometric profile of the card, the biometric profile comprising one or more sets of historical data associated with the biometrics. Next, the method proceeds withs analyzing, by the processor, one or more biometrics associated with a transaction involving the card and determining, by the processor upon analyzing the one or more biometrics associated with the transaction, whether one of the biometrics associated with the transaction deviates from the biometric profile.

Embodiments of the present disclosure provide a system comprising a card further comprising a memory, and a processor configured to record one or more behavioral biometrics, the biometrics associated with orientation and movement of the card. The system further comprises a software application configured to receive, from the card, the biometrics and generate a biometric profile of the card, the biometric profile comprising one or more sets of historical data associated with the biometrics. Next, the application analyzes the biometrics of the card associated with one or more transactions and determine, upon analyzing the biometrics of the card, whether one or more recorded biometrics deviates significantly from the biometric profile.

Embodiments of the present disclosure provide a card comprising a substrate and a body further comprising an accelerometer configured to determine one or more behavioral biometrics associated with the movement of the card.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a diagram illustrating a card according to an exemplary embodiment.

FIG. 3 is a diagram illustrating a card according to an exemplary embodiment.

FIG. 4 is a flowchart illustrating a method according to an exemplary embodiment.

FIG. 5 is a diagram illustrating a card according to an exemplary embodiment.

FIGS. 6A-6D illustrating a card according to an exemplary embodiment.

FIG. 7 is a flowchart illustrating a method according to an exemplary embodiment.

FIG. 8 is a flowchart illustrating a method according to an exemplary embodiment.

FIG. 9 is a diagram illustrating a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present embodiments describe a system and method for authenticating a user via one or more behavioral biometrics associated with a contactless card. Many authentication methods rely on the presence of one or more credentials, such as a card and a phone. But such methods can be easily overcome by a fraudulent party who has stolen every necessary credential. To cure this deficiency, the present authentication method requires a credential that cannot be stolen or easily replicated: the behavioral biometrics of the card. Accordingly, the present embodiments rely on validating the movement of the card in relation to a consumer transaction.

The behavioral biometrics can include the physical orientation of the card in space, the location of the card, the speed at which the card is moved, and other biometrics. The biometrics can be recorded by an accelerometer on the card. As the accelerometer measures the speed and movement of the card, a mobile or web application can generate a user profile based on the card's movements.

The card and software application provide a more secure authentication compared to past methods. For example, a fraudulent party cannot recreate the user's swipe- or tap-behaviors without great difficulty. Additionally, the software application alerts the user to potentially fraudulent behaviors that would go otherwise unnoticed by conventional methods. For example, a typical method for catching frauds is by observing uncommon purchases or odd purchase locations associated with the user's card. However, this method will not catch purchases that are of typical size and in a normal location. In contrast, the present embodiments can catch frauds without relying on purchase behavior, relying instead on behavioral biometrics associated with the card.

The card and software application provide improvements to card technology by, for example, enabling a card to have an accelerometer to track one or more biometrics associated with the movement of the card. As another example, the present application provides an improvement to authentication technology by enabling a software application to generate a biometric profile of a card and determine whether any given transaction involving the physical card is fraudulent.

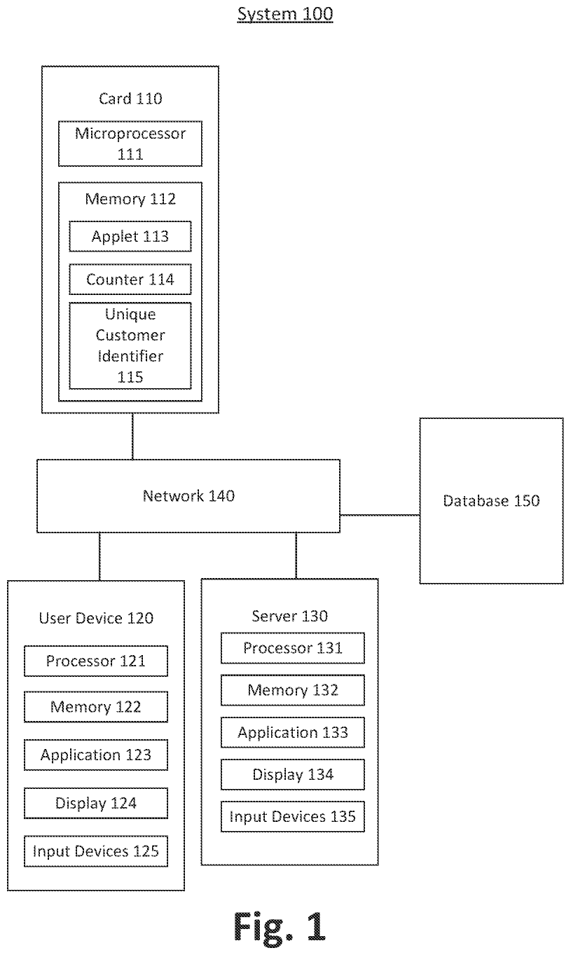

FIG. 1 is a block diagram of a system according to an exemplary embodiment.

FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

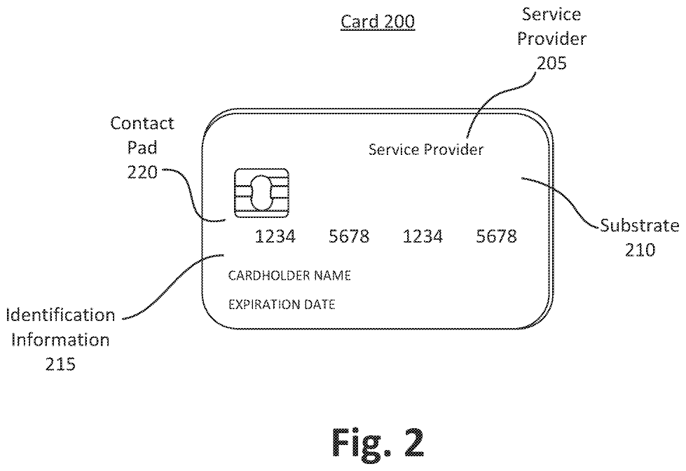

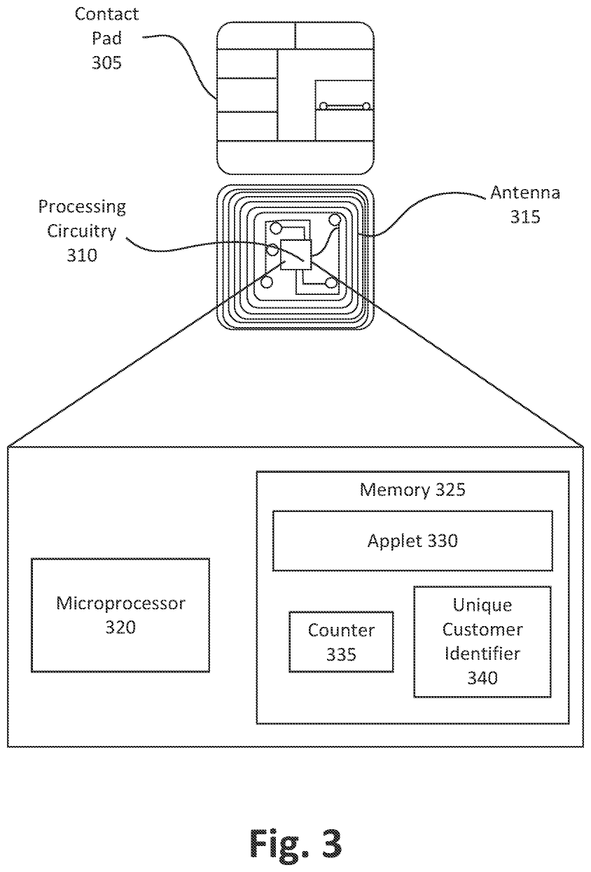

System 100 may include one or more contactless cards 110 which are further explained below with reference to FIG. 2 and FIG. 3. In some embodiments, contactless card 110 may be in wireless communication, utilizing NFC in an example, with user device 120. The contact pad can include processing circuitry and one or more antennae. The processing circuitry can include without limitation a microprocessor 111, a memory 112, an applet 113, a counter 114, and a unique customer identifier 115.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described herein. For example, the application 133 may be executed to perform receiving web form data from the user device 120 or some storage device, retaining a web session between the user device 120 and some storage device, and masking private data received from the user device 120 and some storage device. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that can be available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, and the database 150. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

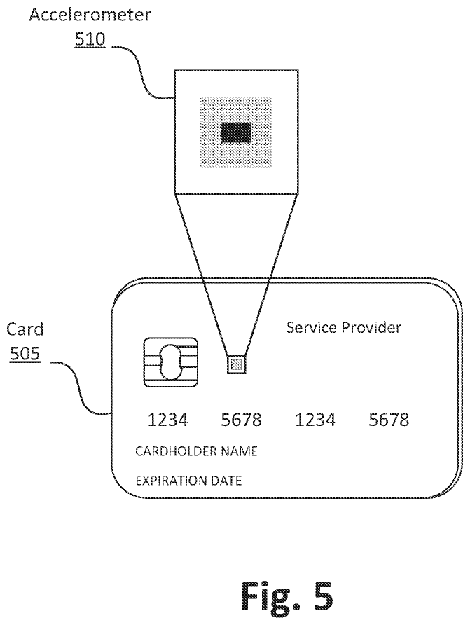

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card. In addition to the elements illustrated in FIGS. 2 and 3, the card can also include an accelerometer discussed with further reference to FIG. 5.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2).

FIG. 3 illustrates a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet, and perform the functions described herein. However, it is understood that applets 330 are not limited to Java Card applets, and instead may be any software application operable on contactless cards or other devices having limited memory. Upon execution by the microprocessor 320, the applet 330 may provide the functions described in this specification, specifically to execute and perform the steps and functions in the process flows described herein. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

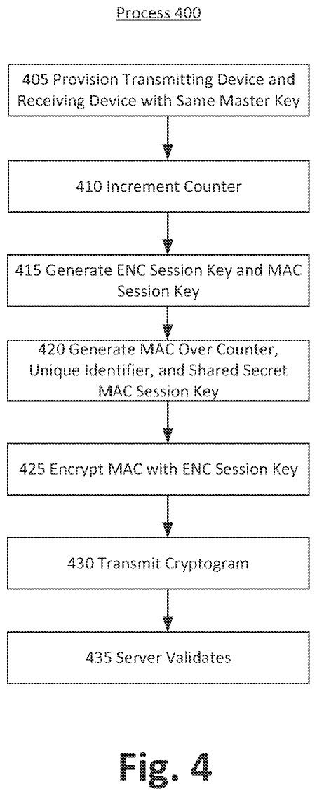

FIG. 4 is a flow chart of method 400 of key diversification according to an example of the present disclosure.

In some examples, a sender and recipient may desire to exchange data via a transmitting device and a receiving device. In some embodiments, the transmitting device is the contactless card, and the receiving device is the server. In other embodiments, the transmitting device and the receiving device are network-enabled computers, as defined herein. As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like. The transmitting device and the receiving device may be network-enabled computer devices. In some examples, the transmitting device may comprise a contactless card and the receiving device may comprise a server. In other examples, the receiving device may comprise a user device or a user device application.

The method 400 can begin with step 405. In step 405, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 410, the transmitting device may take the selected cryptographic algorithm, and using the master symmetric key, process the counter value. For example, the transmitting device may select a symmetric encryption algorithm, and use a counter which updates with every conversation between the transmitting device and the receiving device The one or more counters may comprise a numeric counter sufficient to store an integer. The transmitting device may increment the counter one or more times. In step 415, the transmitting device generates two session keys: one ENC (encryption) session key and one MAC (message authentication code) session key. The transmitting device may encrypt the counter value with the selected symmetric encryption algorithm using the master symmetric key to create a session key.

In step 420, the transmitting device generates the MAC over the counter, the unique customer identifier, and the shared secret MAC session key. The customer identifier may comprise a unique alphanumeric identifier assigned to a user of the contactless card, and the identifier may distinguish the user of the contactless card from other contactless card users. In some examples, the customer identifier may identify both a customer and an account assigned to that customer and may further identify the contactless card associated with the customer's account.

In step 425, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 430, the transmitting device transmits a cryptogram to the receiving device. The cryptogram can include the applet information, the unique customer identifier, the counter value, and the encrypted MAC.

In step 435, the receiving device validates the cryptogram. For example, the receiving device generates its own UDKs (unique diversified keys) using the unique customer identifier and the master key. The unique customer identifier is derived from the validated cryptogram. Recall that the receiving device has already been provisioned with the master key. The receiving device generates two session keys: one ENC (encryption) session key and one MAC (message authentication code) session key. The receiving device may generate these session keys from the UDKs and the counter value. The counter value can be derived from the cryptogram. The receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key. The receiving device validates the MAC with the MAC session key generated in step 415. The receiving device may validate the MAC over the unique customer identifier and the counter value.

FIG. 5 describes a card 505 with an accelerometer 510. Generally, an accelerometer is a device that measures the acceleration of an object. When the object is moved, the acceleration of the object in a certain direction can be observed and recorded by the accelerometer. Thus, the accelerometer can determine when and how an object is moved through space. The accelerometer is sensitive enough to measure both static acceleration (e.g. the force of gravity) and dynamic acceleration (e.g. movement from point A to point B).

The accelerometer can have a mass of predetermined size that can squeeze or act upon a piezoelectric material or some other sensitive material. The piezoelectric material can include without limitation a piezoelectric crystal. When the mass and the piezoelectric material squeeze, an electric charge is produced. The greater the force exerted on the piezoelectric material, the greater the electric charge.

The accelerometer can be either of two main types: a high impedance or low impedance accelerometer. In a high impedance accelerometer, the piezoelectric material or crystal produces an electric charge that is connected directly to the measurement instrument. In a low impedance accelerometer, a device can have a charge accelerometer at one end and at the other end a micro-circuit and field-effect transistor (FET) that can convert the piezoelectric charge into a low impedance voltage.

Accelerometers can be further categorized into analog or digital. Analog accelerometers generate an output of a continuous voltage that is proportional to the acceleration of the object connected to the accelerometer. As a nonlimiting example, the accelerometer can generate a 2.5V for 0.5 g and 2.7V for 1 g. Digital accelerometers typically use pulse width modulation (PWM) for their output. The means that the digital accelerometer will generate a square wave of a certain frequency, and the amount of time that the voltage is high will be proportional to the amount of acceleration. The accelerometer can be 2-axis or 3-axis.

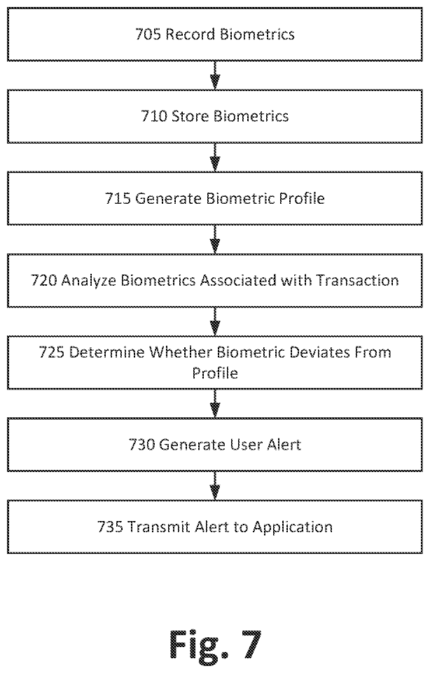

Generally, accelerometers require only low-power inputs. The required current typically falls in the micro or milli-amp range. The card can be configured to house the accelerometer on the body of the card. The accelerometer can be connected to the card's contact pad and processing circuitry. The accelerometer can be configured such that the contact pad can, upon interacting with an electronic device such as a user device or merchant device, transmit information regarding the card's orientation to the device or software application. After a number of transmissions, the software application can build a behavioral biometric profile discussed with further reference to FIG. 7.

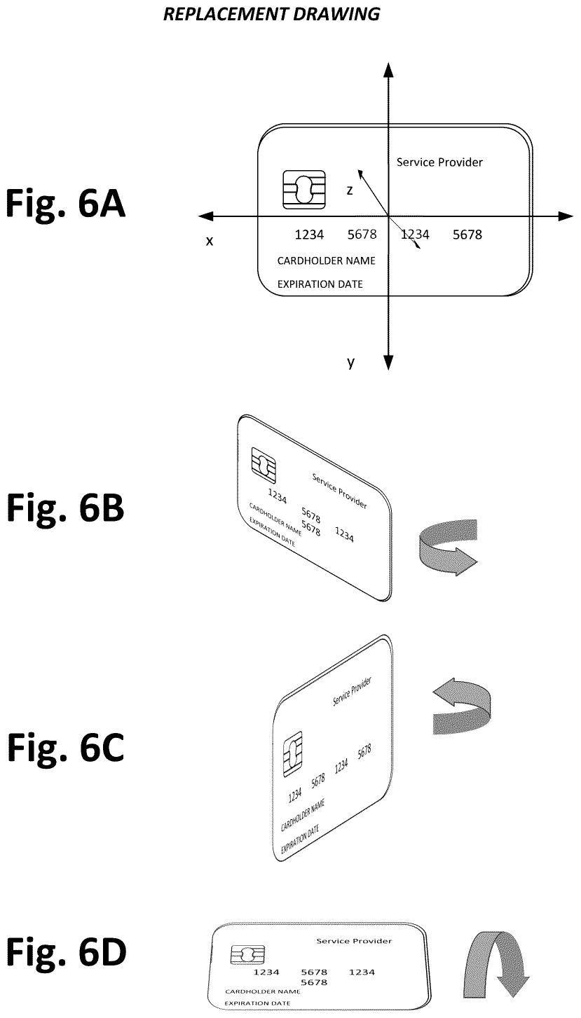

FIGS. 6A-6D are diagrams illustrating a card with an accelerometer according to exemplary embodiments. The accelerometer as depicted in FIG. 6A can measure movement in three dimension or directions: on an x-axis, y-axis, and z-axis. Based on these axes, the accelerometer can measure whether the card is upside down, turned on its side, or in any rotational configuration.

FIGS. 6B-6D illustrate how the accelerometer can measure how the card is being rotated. For example, FIG. 6B illustrates a card rotating around the y-axis in one direction, and FIG. 6C illustrates a card rotating around the y-axis in the other direction. FIG. 6D illustrates a card rotating around the x-axis in one direction, although it is understood that the card can rotate in the either direction. It is understood that the accelerometer can measure any combination of movement or rotation along the x, y, or z-axes.

The accelerometer can determine the orientation of the card in relation to a transaction involving the card, including without limitation an authentication process with a user device or a consumer transaction with a merchant device. As a nonlimiting example, the user may often perform an authentication with their contactless card and their user device, e.g. their smart phone. The user can perform an authentication by tapping their card to their phone. Over a number of authentications, the user may develop a preferred card orientation in relation to the smart phone. For example, the user may always tap their card to the smart phone such that the face of the card with the contact pad is facing the user device. As another nonlimiting example, the user might prefer to tap their card such that the card is upside down. The card can transmit the behavioral biometric information to the user device or mobile application. Over a predetermined number of transmissions, the software application can generate a user profile based on the one or more typical card orientations preferred by the user. The generation of the user profile is discussed with further reference to FIG. 7.

FIG. 7 is a flowchart illustrating a method according to an exemplary embodiment. The method can include a contactless card and a mobile application.

In action 705, the behavioral biometrics associated with a contactless card can be recorded. The behavioral biometrics associated with the contactless card can include without limitation tap and swipe frequency, tap and swipe cadence, tap and swipe speed, tap and swipe location, and the physical orientation of the card. As a nonlimiting example, in a consumer transaction between a user and a merchant device, the user may tap or swipe their card with a typical behavior. In one instance, the card can be tapped for a certain period of time on a merchant device such as a 2 seconds. In another instance, the card can be swiped at a certain speed. In another instance, the card can be tapped to the merchant or user device with a certain card orientation such as upside down. These behavioral biometrics can be observed by the accelerometer and transmitted to a mobile or web application via a user device or merchant device. In other embodiments, the user device or merchant device itself can determine the behavioral biometrics associated with the card use by observing the tap and swipe frequency of the card. For example, the card may be tapped to complete a purchase or transaction at a point of sale terminal. The terminal itself can observe the orientation of the card via a camera. In other embodiments, the accelerometer of the card can record the orientation of the card within a certain time period, either dynamic or predetermined, share the orientation information with the card's microprocessor and/or memory. When the card is tapped, the orientation information stored in the card's memory can be transmitted over a wireless network or communication field with the point of sale terminal. In other embodiments, the orientation information can be shared via the card with a user device.

In action 710, the biometrics can be stored. This action can be performed by the software application or processor associated with a user device or merchant device. The biometrics can be stored in a database or data storage unit associated with a server. The server can be further associated with a mobile application configured to generate the biometric profile of the card.

In action 715, the biometric profile of the card can be generated. In some embodiments, the biometric profile of the card can be generated and trained by a processor or application associated with a user device, merchant processor, or one or more servers including cloud servers. This action can be performed by a mobile or web application, for example. The application can observe a number of behavioral biometrics and, over a predetermined time period, create a profile that reflects the user's typical swipe, tap, and other card-based behaviors. The profile can comprise a predetermined number of categories, such as card orientation and swipe speed. The profile can further categorize the card's biometrics based on what device the card has interacted with. For example, the profile can distinguish between typical card biometrics when interacting with a smart device such as a cell phone as opposed to a merchant device such as a digital register or kiosk. The profile can further categorize the card's behavioral biometrics based on what type of transaction is taking place. For example, the profile can determine whether the user performs a specific card movement for a user-authentication as opposed to a typical consumer transaction. Additionally, the profile can further categorize the card's behavioral biometrics by which specific merchant with whom the user is interacting. For example, the user might tap their card in one fashion with Merchant A but in a different fashion with Merchant B. This difference may be due to a difference in merchant devices used or simple user preference. In another nonlimiting example, the profile can distinguish between using a chip reader, a card tap, or a card swipe.

In action 720, the application can analyze the behavioral biometrics associated with a recent transaction. For example, the application can receive biometric information from a recent purchase at a grocery store. In some embodiments, the application can receive this information over a wireless network from a server associated with the grocery store. In other embodiments, the application can receive the biometric or orientation information from a user device, merchant processor, point of sale terminal processor, kiosk, card reader, or card scanner. It is understood that in other embodiments, other merchants can be used. The application can receive a biometric indicating the card interacted with the merchant kiosk in a certain manner. For example, the card was swiped at the merchant kiosk to purchase groceries. The application can analyze this biometric in relation to the user profile. For example, the application can compare this biometric to past biometrics in relation to the specific merchant, the time of day, the type of purchase, the type of merchant device being used, the card orientation, or some other behavioral biometric.

Upon analyzing the biometric associated with the transaction, in action 725 the application can determine whether the biometric from the recent transaction deviates significantly from the user profile. For example, the processor can determine that in almost every past interaction with the grocery's merchant kiosk, the user's card has been tapped rather than swiped. The application can determine that this is a significant deviation from the card's biometric profile. As another example, the application can determine that the card was tapped to the merchant kiosk for a much longer time period than what has been observed in the past. As another example, the application can determine that the card's orientation during the transaction with the merchant kiosk was significantly different than past orientations. In past interactions with the kiosk, the card may have been tapped to kiosk such that the card was upside down. But in the most recent transaction, the card was tapped right-side up. Therefore, the application can determine that a fraudulent party may be using the card.

Upon determining that a recent transaction is fraudulent, the application can generate a user alert in action 730. The alert can be generated by a processor associated with the user device or server associated with the application.

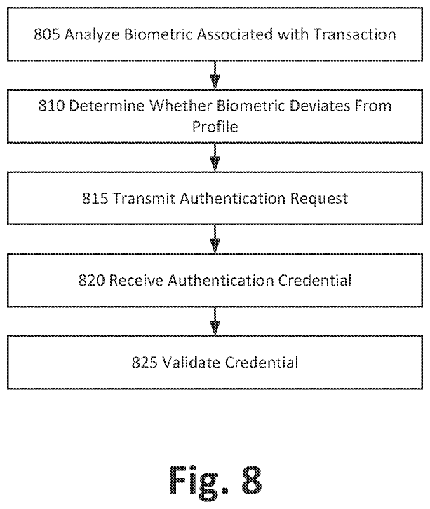

In action 735, the application can transmit the alert the user. The alert can be transmitted over a wireless network. The user can access the alert via the application or their user device. Upon receiving the alert, the user may be prompted to perform an authentication process discussed with further reference to FIG. 8.

FIG. 8 is a method flowchart illustrating an authentication method according to an exemplary embodiment.

In action 805, a recent biometric associated with a transaction involving the contactless card can be analyzed and, in action 810, determined to be a possible fraudulent transaction. These actions can be performed by a processor and are discussed with further reference to FIG. 7. The analysis in action 805 can be performed by a processor associated with a user device; a merchant processor; one or more servers including cloud servers; or some other processor. In some embodiments, the processor can be associated with a software application or web application associated with the user device, merchant processor, or some server. The analysis can include card orientation information, limitation tap and swipe frequency, tap and swipe cadence, tap and swipe speed, tap and swipe location, and the physical orientation of the card. Upon analyzing this information, the processor can determine whether the information.

Upon detecting a potentially fraudulent use of the card, the application can transmit an authentication request to the user in action 815. This action can be performed by the mobile application or by some processor associated with a server. The authentication request can be transmitted to a user device. The authentication request can request without limitation a password, a message authentication code (MAC), a digital signature, a personal identification number (PIN), a biometric, and/or a behavioral biometric associated with card. Biometrics can further include without limitation, fingerprints, writing samples, retinal scans, voice samples, a three-dimensional facial geometry, and any combination thereof. The behavioral biometrics associated with the card can include without limitation tap and swipe frequency, tap and swipe cadence, tap and swipe speed, tap and swipe location, and the physical orientation of the card.

In response to the authentication request, the user can provide an authentication credential in action 820. In some embodiments, the user can transmit a password or other secure information to the application via the user device user interface. In other embodiments, the user device can open a communication field such as a near field communication (NFC) field, Bluetooth, or radio frequency identification (RFID) field. The card can transmit over the communication field a unique customer identifier or account number. Upon opening the communication field, the user device can receive a credential from the contactless card such as a MAC or digital signature. The MAC can be sent via a diversified key exchange discussed with further reference to FIG. 4. As another nonlimiting example, the user can perform a behavioral biometric by tapping the card to the user device via the communication field. For example, the user can tap their card in a certain manner or orientation that matches the user's behavioral biometric profile. In other embodiments, the user can provide a biometric via the user device to the application over a wireless network.

Upon receiving the authentication credential, in action 825 the application can validate the credential. For example, the application can match the credential with a credential associated with the user on file. In some embodiments, the applicant can transmit the credential to a server, at which point the server will validate the credential then transmit a validation message back to the application. For example, the server can match a hashed version of the credential with a hashed user credential on file. Upon validating the credential, the application can continue monitoring the user and the card.

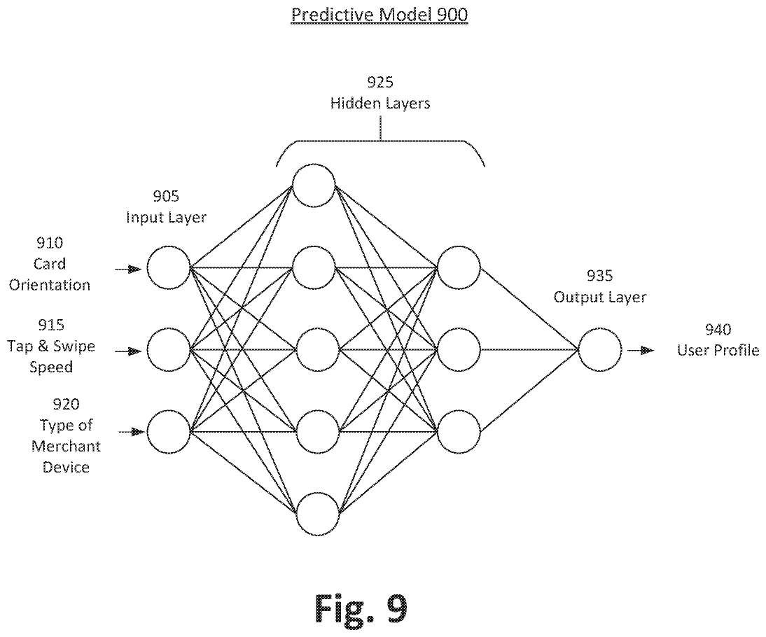

FIG. 9 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. Generally, a neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 900. The neural network may be integrated into the server, the user device, or some other computer device suitable for neural network analysis. The sever can be associated with the software application. The neural network can include generally an input layer 905, one or more hidden layers 925, and an output layer 935. Although only a certain number of nodes are depicted in FIG. 9, it is understood that the neural network according to the disclosed embodiments may include less or more nodes in each layer. Additionally, the hidden layers can include more or less layers than what is depicted in FIG. 9. It is also understood that the connections between each layer may be assigned a predetermined weight according to user's manual change or according to some weight value generated by the neural network itself. The input layer may include sets of data gathered from outside sources. The neural network can include card orientation 910, tap and swipe speed 915, and the type of merchant device 920 that is interacting with the card. Other inputs not depicted in FIG. 9 can include behavioral biometrics associated with the contactless card can include without limitation tap and swipe frequency, tap and swipe cadence, tap and swipe speed, tap and swipe location, and the physical orientation of the card. Upon analyzing the inputs via the one or more hidden layers, the neural network can create a user profile 940. It is understood that one or more neural networks or some combination of neural networks can be trained according to individual users. It is understood that any of the neural networks described herein may be trained or iterated any number of times. In some embodiments, the neural network can be re-trained and/or updated after every recordation of new card biometric data. In still other embodiments, the neural network can be trained until a sufficient level of accuracy has been reached. The neural networks can be trained to arrive at any number of conclusions, including: whether the card orientation matches past biometric data; and whether there is a likelihood of fraud regarding the card's biometrics or orientation.

In some embodiments, the application can analyze biometric using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In some aspects, the techniques described herein relate to a method for secure authentication, the method including the steps of: recording, by a software application, one or more biometrics associated with a card; generating, by the software application, a biometric profile of the card, the biometric profile including one or more sets of historical data associated with the biometrics; analyzing, by the software application, one or more biometrics associated with a transaction involving the card; and determining, by the software application, upon analyzing the one or more biometrics associated with the transaction, whether one of the biometrics associated with the transaction deviates from the biometric profile.

In some aspects, the techniques described herein relate to a method, wherein the one or more biometrics include at least one selected from the group of card orientation, card movement, and card location.

In some aspects, the techniques described herein relate to a method, wherein the steps further include tracking, by an accelerometer on the card, the biometrics.

In some aspects, the techniques described herein relate to a method, wherein the steps further include storing, by the software application, the biometric profile on a server.

In some aspects, the techniques described herein relate to a method, wherein the steps further include generating, by the software application upon receiving the biometrics, a predictive model configured to determine whether one of the biometrics associated with the transaction deviates from the biometric profile.

In some aspects, the techniques described herein relate to a method, wherein the steps further include provisioning, by the software application, a new card with the biometric profile.

In some aspects, the techniques described herein relate to a method, wherein the steps further include: transmitting, by the software application upon determining that one of the biometrics associated with the transaction deviates from the biometric profile, an authentication request to a user device; and receiving, by the software application, an authentication credential from the user device.

In some aspects, the techniques described herein relate to a method, wherein the authentication credential includes at least one selected from the group of a password, PIN, or other biometric.

In some aspects, the techniques described herein relate to a method, wherein the authentication credential is a diversified key exchange between the card and the user device.

In some aspects, the techniques described herein relate to a method, wherein the authentication credential is received over a communication field opened by a processor associated with a user device, the communication field including at least one selected from the group of Bluetooth, near field communication (NFC), and radio frequency identification (RFID).

In some aspects, the techniques described herein relate to a system for secure authentication, the system including: a card including: a memory, and a processor configured to record one or more behavioral biometrics, the biometrics associated with orientation and movement of the card; and a software application configured to: receive, from the card, the biometrics; generate a biometric profile of the card, the biometric profile including one or more sets of historical data associated with the biometrics; analyze the biometrics of the card associated with one or more transactions; and determine, upon analyzing the biometrics of the card, whether one or more recorded biometrics deviates significantly from the biometric profile.

In some aspects, the techniques described herein relate to a system, wherein the card further includes an accelerometer configured to track the orientation and movement of the card.

In some aspects, the techniques described herein relate to a system, wherein the behavioral biometrics include a gait associated with a user.

In some aspects, the techniques described herein relate to a system, wherein the application is further configured to prevent, upon determining that one or more recorded biometrics deviates significantly from the biometric profile, any transactions associated with the card from occurring.

In some aspects, the techniques described herein relate to a system, wherein the system further includes a server configured to update the biometric profile of the card.

In some aspects, the techniques described herein relate to a system, wherein the server is further configured to: transmit, by the software application upon determining that one of the biometrics associated with the transaction deviates from the biometric profile, an authentication request to a user device; and receiving, by the software application, an authentication credential from the user device.

In some aspects, the techniques described herein relate to a system, wherein the card is further configured to transmit the authentication credential over a communication field including at least one selected from the group of Bluetooth, near field communication (NFC), and radio frequency identification (RFID).

In some aspects, the techniques described herein relate to a system, wherein the authentication credential includes a diversified key exchange between the card and the user device.

In some aspects, the techniques described herein relate to a system, wherein the authentication includes at least one selected from the group of a unique customer identifier or account number.

In some aspects, the techniques described herein relate to a card including: a substrate; and a body further including an accelerometer configured to determine one or more behavioral biometrics associated with the movement of the card.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

What is claimed is:

1. A method for secure authentication, the method comprising the steps of:
recording, by a software application, one or more biometrics associated with a card;
generating, by the software application, a biometric profile of the card, the biometric profile comprising one or more sets of historical data associated with the biometrics;
analyzing, by the software application, one or more biometrics associated with a transaction involving the card; and
determining, by the software application, upon analyzing the one or more biometrics associated with the transaction, whether one of the biometrics associated with the transaction deviates from the biometric profile.

2. The method of claim 1, wherein the one or more biometrics comprise at least one selected from the group of card orientation, card movement, and card location.

3. The method of claim 1, wherein the steps further include tracking, by an accelerometer on the card, the biometrics.

4. The method of claim 1, wherein the steps further comprise storing, by the software application, the biometric profile on a server.

5. The method of claim 1, wherein the steps further comprise generating, by the software application upon receiving the biometrics, a predictive model configured to determine whether one of the biometrics associated with the transaction deviates from the biometric profile.

6. The method of claim 1, wherein the steps further comprise provisioning, by the software application, a new card with the biometric profile.

7. The method of claim 1, wherein the steps further comprise:
transmitting, by the software application upon determining that one of the biometrics associated with the transaction deviates from the biometric profile, an authentication request to a user device; and
receiving, by the software application, an authentication credential from the user device.

8. The method of claim 7, wherein the authentication credential comprises at least one selected from the group of a password, PIN, or other biometric.

9. The method of claim 7, wherein the authentication credential is a diversified key exchange between the card and the user device.

10. The method of claim 7, wherein the authentication credential is received over a communication field opened by a processor associated with a user device, the communication field comprising at least one selected from the group of Bluetooth, near field communication (NFC), and radio frequency identification (RFID).

11. A system for secure authentication, the system comprising:
a card comprising:
a memory, and
a processor configured to record one or more behavioral biometrics, the biometrics associated with orientation and movement of the card; and
a software application configured to:
receive, from the card, the biometrics;
generate a biometric profile of the card, the biometric profile comprising one or more sets of historical data associated with the biometrics;
analyze the biometrics of the card associated with one or more transactions; and
determine, upon analyzing the biometrics of the card, whether one or more recorded biometrics deviates significantly from the biometric profile.

12. The system of claim 11, wherein the card further comprises an accelerometer configured to track the orientation and movement of the card.

13. The system of claim 11, wherein the behavioral biometrics include a gait associated with a user.

14. The system of claim 11, wherein the application is further configured to prevent, upon determining that one or more recorded biometrics deviates significantly from the biometric profile, any transactions associated with the card from occurring.

15. The system of claim 11, wherein the system further comprises a server configured to update the biometric profile of the card.

16. The system of claim 11, wherein the server is further configured to:
transmit, by the software application upon determining that one of the biometrics associated with the transaction deviates from the biometric profile, an authentication request to a user device; and
receiving, by the software application, an authentication credential from the user device.

17. The system of claim 16, wherein the card is further configured to transmit the authentication credential over a communication field comprising at least one selected from the group of Bluetooth, near field communication (NFC), and radio frequency identification (RFID).

18. The system of claim 16, wherein the authentication credential comprises a diversified key exchange between the card and the user device.

19. The system of claim 16, wherein the authentication comprises at least one selected from the group of a unique customer identifier or account number.

20. A card comprising:
a substrate; and
a body further comprising an accelerometer configured to determine one or more behavioral biometrics associated with one or more movements of the card.
